(19) United States
(12) Patent Application Publication
(10) Pub. No.: US 2026/0064640 A1
(43) Pub. Date: Mar. 5, 2026

(54) AUTOMATIC REPORT POPULATION WITH MACHINE LEARNING MODELS

(71) Applicant: Fluke Corporation, Everett, WA (US)

(72) Inventors: Seyed Navid Roohani Isfahani, Seattle, WA (US); Matthew F. Schmidt, River Falls, WI (US); Nirav Narendra Dedhiya, Lynwood, WA (US); Shreyas Shivaram Shastry, Lynnwood, WA (US)

(21) Appl. No.: 18/816,976

(22) Filed: Aug. 27, 2024

(51) Int. Cl. G06F 16/21; G06F 9/451

(52) U.S. Cl. CPC G06F 16/21; G06F 9/451

(57) ABSTRACT

Provided are systems and methods for automatic ingestion and generation of reports. In particular, some example implementations can include and use one or more machine-learned sequence processing models such as large language models (LLMs) and large multimodal models (LMMs) to process a data file that depicts prior renderings of reports.

### FIELD

The present disclosure relates generally to machine learning processes and machine-learned devices and systems. More particularly, the present disclosure relates to systems and methods that use machine learning models to perform automatic report ingestion and population.

### BACKGROUND

In the field of data processing, particularly in automatic report generation, several technical challenges impact efficiency and accuracy. Traditional methods for extracting data from image files, like manual entry or basic optical character recognition (OCR), are often inefficient and prone to errors. These methods struggle with complex layouts and poor image quality, necessitating a more sophisticated automated system for accurate data extraction.

In particular, generating structured data from unstructured sources such as image files frequently results in inaccuracies due to limitations in existing technologies. These inaccuracies can lead to data misinterpretations in the final reports, highlighting the need for improved precision in structured data generation.

Furthermore, current data processing systems generally lack dynamic adaptability to new data inputs or user preferences, requiring extensive manual reconfiguration to adjust to changes in data structures or reporting requirements. This rigidity limits the system's utility and adaptability.

In addition, many systems do not adequately support the automatic integration of graphical data into reports, often necessitating manual steps to include visual data, which reduces overall process efficiency.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method for automatic generation of reports. The computer-implemented method includes obtaining, by a computing system may include one or more computing devices, a data file associated with a prior instance of a report or report type. The method also includes processing, by the computing system, the data file with one or more machine-learned sequence processing models to generate template report structure data as an output of the one or more machine-learned sequence processing models, where the template report structure data defines a template structure of the report or report type. The method also includes retrieving, by the computing system, one or more data records from a datastore based on a user input. The method also includes processing, by the computing system, the template report structure data and the retrieved one or more data records with the one or more machine-learned sequence processing models to generate populated report data as an output of the one or more machine-learned sequence processing models, where the populated report data may include a new instance of the report or report type that is structured according to the template report structure data and populated according to the one or more data records.

Another general aspect includes a computing system for automatic generation of reports. The computing system includes a report ingestion system configured to: obtain a data file associated with a prior instance of a report; and process the data file with one or more machine-learned sequence processing models to generate template report structure data as an output of the one or more machine-learned sequence processing models, where the template report structure data defines a template structure of the report or report type. The system also includes a data retrieval system configured to retrieve one or more data records from a datastore based on a user input. The system also includes a report completion system configured to process the template report structure data and the retrieved one or more data records with the one or more machine-learned sequence processing models to generate populated report data as an output of the one or more machine-learned sequence processing models, where the populated report data may include a new instance of the report or report type that is structured according to the template report structure data and populated according to the one or more data records.

Implementations of the described techniques may include hardware, a method or process, or computer software on a computer-accessible medium.

### BRIEF DESCRIPTION OF THE DRAWINGS

FIG. 1 provides a block diagram illustrating data flow in an example automated report ingestion and generation system according to example implementations of the present disclosure.

FIG. 2 provides a block diagram illustrating data flow in an example automated report ingestion system according to example implementations of the present disclosure.

FIG. 3 provides a block diagram illustrating data flow in an example data retrieval system according to example implementations of the present disclosure.

FIG. 4 provides a block diagram illustrating data flow in an example automated report generation system according to example implementations of the present disclosure.

FIG. 5 provides an example user interface that enables a user to explore and select a particular set of data records according to example implementations of the present disclosure.

FIG. 6 provides an example user interface that enables a user to explore and select a particular set of data records according to example implementations of the present disclosure.

FIG. 7 provides an example user interface that enables a user to explore and select a report template from a set of saved templates according to example implementations of the present disclosure.

FIG. 8 provides an example user interface that ingests a prior report to create a new template according to example implementations of the present disclosure.

FIG. 9 illustrates an example report according to example implementations of the present disclosure.

FIG. 10 provides an example user interface that displays the generated template report structure data to users in a panel on the right side according to example implementations of the present disclosure.

FIG. 11 provides an example user interface that displays a rendering of template report structure data to users according to example implementations of the present disclosure.

FIG. 12 provides an example user interface that displays a rendered report of populated report data to users according to example implementations of the present disclosure.

FIG. 13 provides an example user interface that enables a user to enter a natural language description of a report to be generated according to example implementations of the present disclosure.

FIG. 14 provides an example user interface that displays: the user input, the generated template report structure data to the user in the right side panel, and the retrieved data records in the panel shown on the right side according to example implementations of the present disclosure.

FIG. 15 provides an example user interface that displays the user input, the generated template report structure data to the user, and the retrieved data records in the left side panel and displays the populated report data in the right side panel according to example implementations of the present disclosure.

FIG. 16 provides an example user interface that displays a rendered report that includes a graphical depiction of data according to example implementations of the present disclosure.

FIG. 17 provides an example user interface that enables a user to provide a user edit to a generated report according to example implementations of the present disclosure.

FIG. 18 provides an example user interface that displays a re-generated report that has been modified based on user feedback according to example implementations of the present disclosure.

FIG. 19 provides a flowchart of an example method for training machine-learned models according to example implementations of the present disclosure.

FIG. 20 illustrates an example implementation of a sequence processing model capable of processing sequences of information according to example implementations of the present disclosure.

FIG. 21 presents an example implementation of a multi-modal sequence processing model according to example implementations of the present disclosure.

FIG. 22 depicts an example training flow for training a machine-learned development model according to example implementations of the present disclosure.

FIG. 23 presents a block diagram of a networked computing system capable of executing the disclosed techniques according to example implementations of the present disclosure.

Similarly named components within the Figures may demonstrate different aspects or variations of a particular component. The components illustrated in the Figures may be combined (or not) in various ways to demonstrate the full scope of example implementations of the present disclosure.

### DETAILED DESCRIPTION

Example aspects of the present disclosure are directed to systems and methods for automatic generation of reports. In particular, some example implementations can include and use one or more machine-learned sequence processing models such as large language models (LLMs) and large multimodal models (LMMs) to process a data file that depicts one or more prior renderings of one or more reports. For example, the data file could be an image file (e.g., .jpeg, .jpg, .png, etc.), a text file (e.g., .docx), a Portable Document Format (PDF) file, and/or other file formats. Specifically, the sequence processing model(s) can analyze the data file that depicts the prior rendering of the report or report type to generate template report structure data, which can define a template structure of the depicted report. For instance, in some implementations, the system can process PDF documents or other images of reports to extract structural data, which is then used to create the template report structure data. For example, the template report structure data can be expressed in a markup language such as Hypertext Markup Language (HTML). Then, the one or more machine-learned sequence processing models can be further used to process the template report structure data and one or more retrieved data records to generate populated report data. For example, the sequence processing model(s) can analyze the data records and the template report structure data to create populated report data. The populated report data can correspond to a new instance of the report or report type that is structured according to the template report structure data and populated according to the one or more data records. The populated report data can be rendered to generate a rendered report that visually illustrates the data from the data records inserted into the report structure. Thus, the proposed systems and methods significantly enhance the automation and accuracy of report generation from image data by utilizing advanced machine-learned sequence processing models. These models can streamline the extraction and structuring of data, adapt dynamically to user inputs and preferences, and efficiently integrate complex graphical content, thereby improving the overall functionality and reliability of data processing systems.

According to one aspect of the present disclosure, in some implementations, a multi-step reinforcement approach can be performed when generating the template report structure data. For example, a report ingestion system can use the machine-learned sequence processing model(s) to iteratively refine the generated template report structure data. Initially, the system processes the image data with a first instantiation of the models to create an initial set of template report structure data. Subsequently, this data, potentially along with a reinforcement prompt, is processed by a second instantiation of the models. This reinforcement prompt can guide the models to refine the initial data based on predefined guidelines or checklists, enhancing the accuracy and relevance of the template structure.

In some implementations, the sequence processing models employed in the present disclosure can be specifically finetuned on a supervised training dataset to improve their performance. For example, this dataset can include pairs of training images of reports and corresponding ground truth template report structure data. By training on such datasets, the models can better understand and predict the structural elements of reports from various image data inputs, leading to more accurate template generation.

In some implementations, the computing system can leverage one or more system prompts to guide the sequence processing models during the report generation process. These prompts can be dynamically generated based on the context of the data being processed or can be predefined based on specific user requirements. For instance, a system prompt may instruct a sequence processing model to focus on certain areas of a data file when generating template report structure data, or to prioritize specific types of data during the data retrieval process from the datastore. As another example, a system prompt can provide a set of guidelines or guardrails which control (e.g., via context setting) the output of the sequence processing model to improve accuracy and/or adherence to certain objectives. These prompts not only facilitate a more targeted data processing approach but also enhance the adaptability of the system to handle diverse data processing scenarios effectively.

Another aspect of the present disclosure relates to the generation of a dictionary of data labels through the processing of the data file that depicts the report or report type. For example, the sequence processing model(s) can be guided by a label identification prompt, which instructs the model(s) to identify and categorize labels contained within the prior rendering of the report or report type. For example, labels such as “Date,” “Total Amount,” and “Recipient” can be identified and used to structure the report template accordingly. This dictionary can be implemented in various programming languages, such as a Python dictionary, to facilitate integration and manipulation within the system.

Another aspect of the present disclosure is directed to a user interface component that displays the generated template report structure data to users. Users can make edits and adjustments to this data through the interface, which are then captured by the system. These user inputs can be processed and stored, allowing for the customization of the report template according to specific user requirements or preferences. In some implementations, the user can interact with the user interface component to directly edit the generated template report structure data. Alternatively or additionally, the user interface can include a chat functionality that enables interaction with a sequence processing model in a turn-based fashion in which the user provides a natural language description of desired edits to the template report structure data and the sequence processing model edits (e.g., re-generates) the template report structure data in response to the natural language descriptions provided by the user. Once satisfied, the user can save the template report structure data to a database.

In some implementations, to enhance the functionality of the sequence processing models, the present disclosure provides for the finetuning of these models based on the user edits to the template report structure data received via the user interface component. This adaptive learning approach allows the models to continually improve and adjust to new data inputs and user feedback, thereby increasing the system's overall efficiency and accuracy in report generation.

Another aspect of the present disclosure is directed to data retrieval techniques where the system can process user inputs received through a graphical user interface. These inputs may specify certain data elements, or comprise a query expression or a natural language expression. The system then processes these inputs (e.g., along with system configuration specifications to the sequence processing model), to retrieve the corresponding data records from the datastore, which are used to populate the report or report type. For example, a system prompt can include the system configuration specifications which provide guardrails for security and authenticity of data retrieved. This feature supports a variety of user input methods, making the system flexible and user-friendly.

Another aspect of the present disclosure is directed to the processing of the template report structure data and retrieved data records by the sequence processing model(s) to generate populated report data. This can include the use of a datastore description prompt, which provides the sequence processing models with a description of the structure or schema of the datastore from which data records are retrieved. This information aids the models in accurately mapping the retrieved data into the report or report type based on the template structure and/or the dictionary of data labels.

In some implementations, the report can include a graphical depiction of data such as a chart. In this case, the template report structure data may include a template description of the graphical depiction of data. Similarly, the populated report data may include graphical data for rendering graphical data depictions within the report or report type. The sequence processing models can generate these graphical data elements with the help of (e.g., by being prompted using) a graphics library description prompt, which outlines the use of a specific graphics library suitable for building these graphical depictions. This feature can be particularly useful for generating visual representations such as charts and graphs within the report or report type, enhancing the report's visual appeal and readability.

Some example implementations of the present disclosure include a modular computing system that includes a report ingestion system, a data retrieval system, and a report completion system. Each of these systems can be specifically configured to handle different aspects of the report generation process, from obtaining and processing image data to retrieving data records and generating the final populated report. This modular approach allows for efficient management and maintenance of the system, ensuring robust performance across different use cases.

The systems and methods of the present disclosure provide a number of technical effects and benefits. As one example, the proposed techniques provide enhanced data processing efficiency. In particular, the use of machine-learned sequence processing models facilitates the automatic extraction and structuring of data from image files depicting prior renderings of reports. This technology effectuates a more efficient data processing workflow, as the models can accurately interpret and convert visual data into structured report formats. The technical benefit here is the reduction in computational overhead and increased speed of data conversion from unstructured to structured formats.

Another example technical effect is improved accuracy in data extraction. In particular, by employing machine-learned models that are finetuned on supervised training datasets, the system achieves high accuracy in identifying and categorizing data elements within data files that depict prior renderings of reports. This technical effect ensures that the data extracted from example input data files closely matches the combination of structured or unstructured data from a database associated with the documents, thereby minimizing errors in the subsequent reports generated. This is particularly beneficial in a computing context where precision in data handling is of high importance.

Another example technical effect is dynamic adaptation through user interaction. In particular, the system's capability to incorporate user edits and subsequently refine the outputs generated by machine-learned models based on these inputs introduces a dynamic editing process within the computing system. Furthermore, in cases where the underlying machine-learned models are then re-trained or finetuned on the edited data, the model's performance can be improved over time.

Another example technical effect of the present disclosure is automated data labeling and dictionary creation. In particular, the technology automates the process of identifying labels in the reports and creating dictionaries based on these labels. This technical effect facilitates the structured organization of data, which is beneficial for systematic data handling and retrieval in computing systems. The creation of dictionaries, such as Python dictionaries, allows for easier manipulation and access to data within the system.

Another example technical effect of the present disclosure relates to complex query handling and data retrieval. In particular, the system's ability to process natural language expressions and convert them into structured query expressions for data retrieval introduces a significant technical effect. This capability enhances the functionality of the datastore querying process, allowing for more complex and nuanced data retrieval operations. This is a direct benefit to the computing system, as it extends the system's ability to interact with and extract data from diverse data sources based on user-defined criteria. Furthermore, this capability also enables the user to guide retrieval of the correct data records without needing knowledge of a specific structured query language.

Another example technical effect relates to improved graphical data processing. In particular, the inclusion of a graphics library description prompt to assist in the generation of graphical data for reports introduces a technical effect related to the handling and rendering of graphical content. This capability enables the system to automatically select and utilize appropriate graphics libraries for rendering visual data elements, optimizing the graphical output for reports and ensuring compatibility with various data formats.

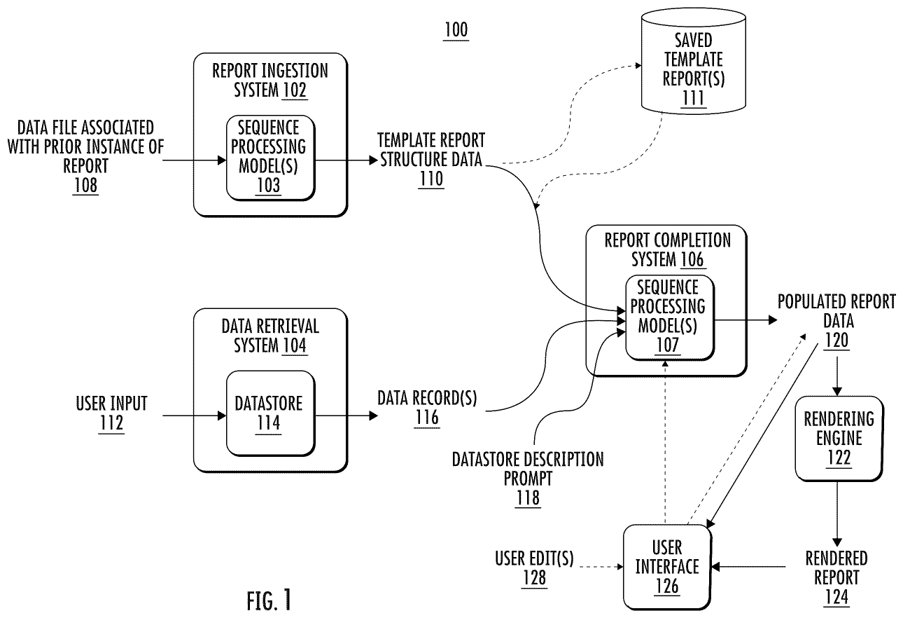

Referring now to FIG. 1, a block diagram is provided to illustrate the data flow within an example automated report ingestion and generation system 100, according to example implementations of the present disclosure.

The report ingestion system 102 is a component of the system 100, configured to process a data file 108 that depicts a prior instance of a report. The data file 108 can be or include various types of data files. For example, the data files can include formats such as JPEG, PNG, PDF, DOCX, among others, allowing for flexibility in the types of data file that the system can process. In particular, in some instances, the initial input data file 108 might be an actual image file (e.g., a jpg, png, or .bmp screenshot of an example report), but in other cases the input data file 108 might be a file format like .pdf, .docx, etc. of an actual example report, which can contain both content (e.g., images, data to be displayed) along with structure information about how/where that info is to be laid out on a page. As yet another example, in some cases, the initial input could be a template file (e.g. in .docx, .xml, .html, etc. format) that contains only the layout structure data but no actual data content. The capability to handle multiple different input file formats can enhance the system's adaptability to different sources and formats of report data, thereby improving the efficiency of the report ingestion process.

A prior instance of a report or report type can refer to a previously created or generated report that serves as a reference or example for a particular reporting process or report type. This prior instance can contain data, analysis, and/or formatting that are pertinent to a specific context or purpose, and can be used as a template or benchmark for creating new reports (e.g., which may be referred to as new instances of the report or report type). Thus, the prior instance can be representative of a particular report or type of report, embodying specific structural and content-based characteristics that are relevant to that reporting process and/or report category, thereby guiding the generation of subsequent instances of the same report or report type.

A “report type” can generally refer to collection of different reports that share certain content, purpose, format, and/or audience. A report type can include reports that have a specific structure, data requirements, and/or presentation style that are appropriate for a particular reporting objective. Report types can vary widely across different fields and industries, including but not limited to financial reports, technical reports, business analytics, research papers, and progress updates.

An instance of a report or report type can refer to a specific occurrence or example of a report or report type that has been created, generated, or used at a particular point in time. An instance can include the unique content, structure, and/or data specific to that particular report, distinguishing it from other instances of the report or report type. Each instance can serve as a snapshot of the information and layout as they were configured and presented in that specific report, capturing the details and characteristics relevant to its intended purpose or audience at the time of its creation.

Referring still to FIG. 1, the system includes a sequence processing model(s) 103, which analyzes the image data to generate template report structure data 110. In some implementations, the sequence processing model(s) can be or include large language models (LLMs) and/or large multi-modal models, such as vision-language models. These models can efficiently process and analyze complex data types, where LLMs are particularly beneficial for interpreting and generating textual content, and vision-language models excel in tasks that require an understanding of both visual and textual inputs. For instance, a vision-language model can analyze an image of a report while simultaneously interpreting textual annotations or embedded text within the image, thereby facilitating a more integrated and comprehensive data processing approach.

The template report structure data 110 defines a template structure of the report. In some implementations, the template report structure data 110 can be expressed in Hypertext Markup Language (HTML) or other markup languages such as XML (extensible Markup Language). This allows for the structured presentation of the report elements, facilitating easy integration and manipulation within web-based platforms. For example, using HTML enables the system to seamlessly embed various multimedia elements and links within the report, enhancing the interactivity and accessibility of the generated reports.

In some implementations, the template report structure data 110 can be stored as saved template report(s) 111 in a database or other suitable storage medium, facilitating future access and utilization. This storage allows for the efficient reuse and further refinement of the template report structure data, enhancing the adaptability and efficiency of the report generation system by providing a foundation for subsequent report preparations without the need for reprocessing the original image data.

Adjacent to the report ingestion system 102 is the data retrieval system 104, which interacts with a datastore 114. The datastore 114 contains various data records that can be retrieved based on user input 112. For example, the data records stored in the datastore 114 can include a value pertinent to one of the data labels included in the template report structure data 110 generated by the model(s) 103. The data retrieval system 104 facilitates the extraction of these data records 116, which are used for populating the template report structure with corresponding data values from the datastore/database 114.

The report completion system 106 further processes the template report structure data 110 and the retrieved data records 116 using sequence processing model(s) 107. This results in populated report data 120, which includes the template structure populated with data from the data records 116. Thus, the sequence processing models 107 can be configured to intelligently map and insert the data from the records into the appropriate sections of the template, ensuring that the populated report data 120 maintains a coherent and logical structure conducive to easy comprehension and analysis.

In particular, in some implementations, the populated report data 120 can include or correspond to a new instance of the report or report type that is structured according to the predefined template report structure data 110. The new instance of the report can have been populated with specific data extracted from one or more data records 116 retrieved from a datastore. Thus, the data records 116 can provide the actual content that fills the predefined sections defined by the template report structure data 110.

In some implementations, a datastore description prompt 118 may be provided as a conditioning input to the sequence processing model(s) 107 to aid in accurately mapping the retrieved data into the report based on the template structure. This prompt 118 may include metadata or schema information about the datastore, enabling the sequence processing models to better understand the organization and format of the data, thus enhancing the precision with which data is integrated into the report's predefined template.

The populated report data 120 is then provided to a rendering engine 122, which generates a rendered report 124. This rendered report 124 visually illustrates the data from the data records inserted into the report structure, enhancing readability and presentation.

Moreover, the system 100 includes a user interface 126, which allows users to make edits (user edits 128) to the template report structure data. These edits can be processed by the report completion system 106, demonstrating the system's adaptability to user preferences and requirements. The user interface 126 serves as a point of interaction for users to customize the report templates according to their specific needs.

In some implementations, the sequence processing models 103, 107 employed in the report ingestion system 102 and report completion system 106, respectively, can be fine-tuned or adapted based on the user edits 128 received via the user interface 126. This adaptive learning approach allows the models to continually improve and adjust to new data inputs and user feedback, thereby increasing the system's overall efficiency and accuracy in report generation.

The modular architecture of the system 100, as illustrated in FIG. 1, allows for efficient management and maintenance of the system, ensuring robust performance across different use cases. This design not only simplifies the process of report generation but also enhances the flexibility and scalability of the system to meet diverse user demands and data processing requirements.

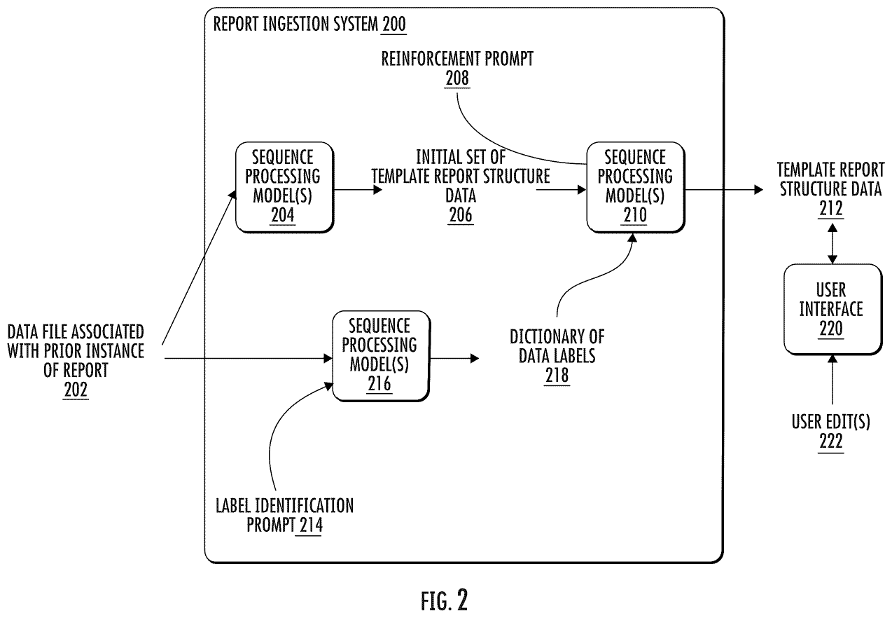

Referring now to FIG. 2, a block diagram is provided to illustrate the data flow within an example report ingestion system 200, according to example implementations of the present disclosure.

The report ingestion system 200 starts with the data file 202 associated with a prior instance of a report. This data file 202 is processed by sequence processing model(s) 204, which are part of the machine learning framework employed to extract initial structured data from the data file 202. The output from this initial processing is an initial set of template report structure data 206, which defines a preliminary structure of the report based on the content recognized in the image data 202.

To enhance the accuracy and relevance of the initial template report structure data 206, a reinforcement prompt 208 is used. This prompt 208 guides a second instantiation of the sequence processing model(s) 210 to refine the initial data. The refinement process may involve adjusting the structure, correcting errors, or filling in missing elements that were not adequately captured or were misinterpreted in the initial processing stage. The refined output is the template report structure data 212, which is a more accurate and complete representation of the report's structure as intended for further processing and final report generation.

In parallel, the system 200 employs another instantiation of sequence processing model(s) 216 to process the image data 202 with a specific focus on label identification, guided by a label identification prompt 214. This process is aimed at identifying and categorizing various data labels present in the image data, such as “Date”, “Total Amount”, “Recipient”, etc. The output from this process is a dictionary of data labels 218, which stores these identified labels in a structured format, such as a Python dictionary, facilitating their integration and manipulation within the system.

In some implementations, the template report structure data 212 and the dictionary of data labels 218 are then made available to a user interface 220. This interface allows users to view and interact with the generated template and labels. Users can make edits or adjustments to the template report structure data through the user interface 220, and these modifications are captured as user edits 222. These edits can be processed back into the system to update the template report structure data 212, thereby allowing the system to adapt to specific user requirements or preferences, enhancing the customization capability of the report generation process.

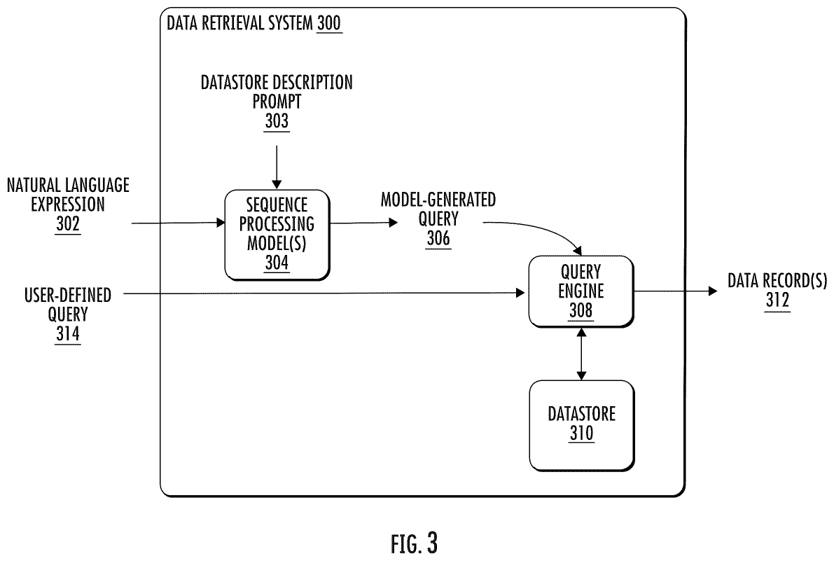

Referring now to FIG. 3, a block diagram is provided to illustrate the data flow within an example data retrieval system 300, according to example implementations of the present disclosure. The data retrieval system 300 includes sequence processing model(s) 304, which are configured to process inputs and generate queries that are used to retrieve data from a datastore 310.

The input to the data retrieval system 300 can come from two primary sources: a natural language expression 302 and/or a user-defined query 314. The natural language expression 302 allows users to input queries in a conversational, unstructured format, which the sequence processing model(s) 304 processes to understand and transform into a structured model-generated query. This capability is particularly beneficial for users who may not be familiar with formal query languages.

In some implementations, the sequence processing model(s) 304 utilizes a datastore description prompt 303 to better understand the structure or schema of the datastore 310. This prompt can provide metadata or schema information about the datastore 310, which assists the sequence processing model(s) 304 in accurately interpreting the user's intent and generating a valid query. Additionally, the datastore description prompt 303 includes built-in guardrails to ensure the security, integrity, and authenticity of the data retrieval process. For example, these guardrails can include integrity checks that validate the accuracy and completeness of the data being retrieved and/or authenticity measures that confirm the legitimacy of the data sources. The output from the sequence processing model(s) 304 is a model-generated query 306, which is a structured query that is ready to be executed by the query engine 308. In some implementations, the model-generated query 306 can be surfaced to the user who can approve or edit the model-generated query 306 before the query 306 is executed.

The query engine 308 is responsible for executing the model-generated query 306 against the datastore 310. The datastore 310 contains various data records 312 that can be retrieved based on the query provided by the query engine 308. The query engine 308 interacts directly with the datastore 310, retrieving data records 312 that match the criteria specified in the model-generated query 306.

Additionally or alternatively to the data flow described above, the data retrieval system 300 can directly receive a user-defined query 314. In some cases, the user-defined query 314 can be an ad hoc query generated by the user. In other cases, the user-defined query can be one of a number of pre-defined queries that the user selects (e.g., from a drop down menu). This feature allows advanced users to directly interact with the system using their technical knowledge of query languages and/or by selecting a pre-defined query from a set of available queries, thereby bypassing the natural language processing step if desired. In yet further examples, a user interface can be provided by which the user is able to directly select the data records 312 from retrieval from the datastore 310.

The configuration of the data retrieval system 300, as illustrated in FIG. 3, allows for flexible interaction with users of varying levels of technical expertise. By accommodating both natural language expressions and user-defined queries, the system enhances accessibility and usability for a broader user base. Furthermore, the use of sequence processing models to interpret and transform natural language inputs into structured queries reduces potential errors and improves the efficiency of data retrieval processes.

The configuration of the data retrieval system 300 not only streamlines the data retrieval process but also ensures that the data extracted from the datastore is accurate and relevant to the user's request. The integration of a datastore description prompt 303 to inform the sequence processing models 304 further enhances the precision of query generation, ensuring that the system's interactions with the datastore are optimized for accuracy and efficiency.

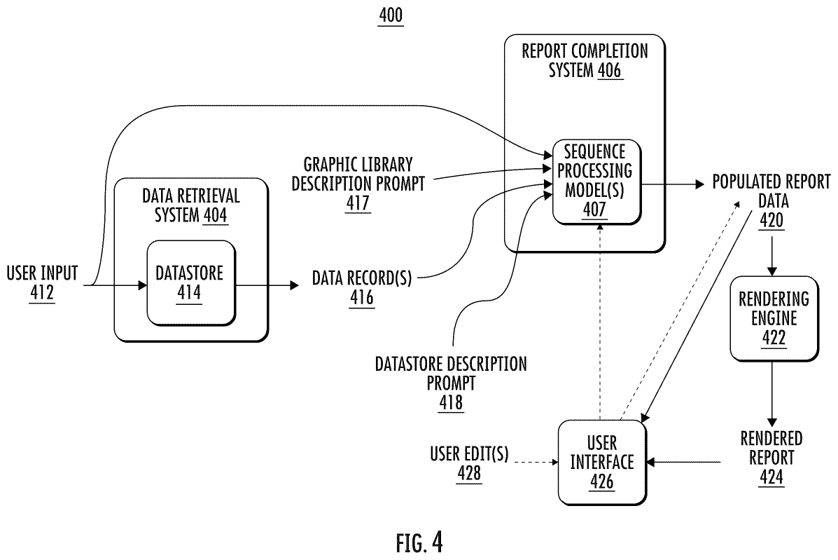

Referring now to FIG. 4, a block diagram is provided to illustrate the data flow within an example automated report generation system 400, according to example implementations of the present disclosure. The system 400 can operate to generate populated report data 420 based on a user input 412. In some implementations, the system 400 may be implemented as a feedback loop present within the system 100 of FIG. 1. In other implementation, system 400 may be implemented as a standalone system or workflow.

In some implementations, the user input 412 can include a description of a desired report structure, content, or graphical elements. For example, the user input 412 may request the generation of a report that includes a chart illustrating data trends for specific data records over a defined period. This feature enables users to customize reports to include visual representations such as graphs or charts that provide insights into data variations and patterns, enhancing the report's utility and readability.

The data retrieval system 404 serves as a component of the system 400, configured to interact with a datastore 414. User input 412, which can be in the form of a query expression or a natural language expression (e.g., as described with reference to FIG. 3), is received by the data retrieval system 404. This input guides the system to retrieve relevant data record(s) 416 from the datastore 414.

The system 400 also includes the report completion system 406, which includes sequence processing model(s) 407. These model(s) process the user input 412 and the retrieved data record(s) 416 to generate populated report data 420, which is a structured compilation of the data records formatted according to user input.

In some implementations, a datastore description prompt 418 can be employed as a conditioning input to the sequence processing model(s) 407. This prompt can include metadata or schema information about the datastore, which assists the sequence processing models in understanding the organizational structure of the datastore. Thus, the datastore description prompt 418 can include specific guardrails to control the content returned during the query process. Examples of guardrails that can be included in the prompt 418 include any configuration information provided to condition the model 407, such as the specific libraries it can use, words/responses to stay away from (e.g., which can be referred to as “content moderation”), etc. For example, the prompt may specify that only HTML code or SQL queries should be returned, ensuring that the output adheres to predefined formats and standards. Furthermore, backend guardrails can be implemented to authenticate that the content is fetched from designated tables in the datastore, enhancing the security and integrity of the data retrieval process. By providing the datastore description prompt 418, the models can more effectively interpret the user's input and accurately map the retrieved data into the report according to the predefined template structure, thereby enhancing the precision and relevance of the populated report data.

In some implementations, a graphics library description prompt 417 can be provided as a conditioning input to the sequence processing model(s) 407 to assist in creating populated report data 420 that accurately leverages a graphics library for graphically depicting data. For instance, the graphics library description prompt 417 can include specifications or parameters that guide the sequence processing model(s) 407 in selecting appropriate graphical styles, formats, or functions from the graphics library, ensuring that the graphical representations in the report, such as charts or diagrams, are visually appealing, informatively accurate, and formatted consistently from one report to another. This aids in enhancing the visual communication of data insights within the generated reports. Thus, in some implementations, the populated report data 420 includes graphical elements such as, for example, charts and/or graphs.

The populated report data 420 is then forwarded to a rendering engine 422, which converts the structured data into a visually appealing rendered report 424. This report is designed to be both informative and easy to interpret, incorporating both textual and graphical data in a user-friendly format.

Additionally, the system 400 includes a user interface 426, which allows for dynamic interaction with the system. Users can provide edits or modifications to the report structure or content through user edit(s) 428. These edits are fed back into the report completion system 406, allowing the sequence processing model(s) 407 to reprocess the data in light of the user's modifications, thereby enhancing the customization and relevance of the final report.

This configuration of the system 400 not only facilitates efficient and accurate report generation but also incorporates flexibility and user customization, making it highly adaptable to various user requirements and preferences.

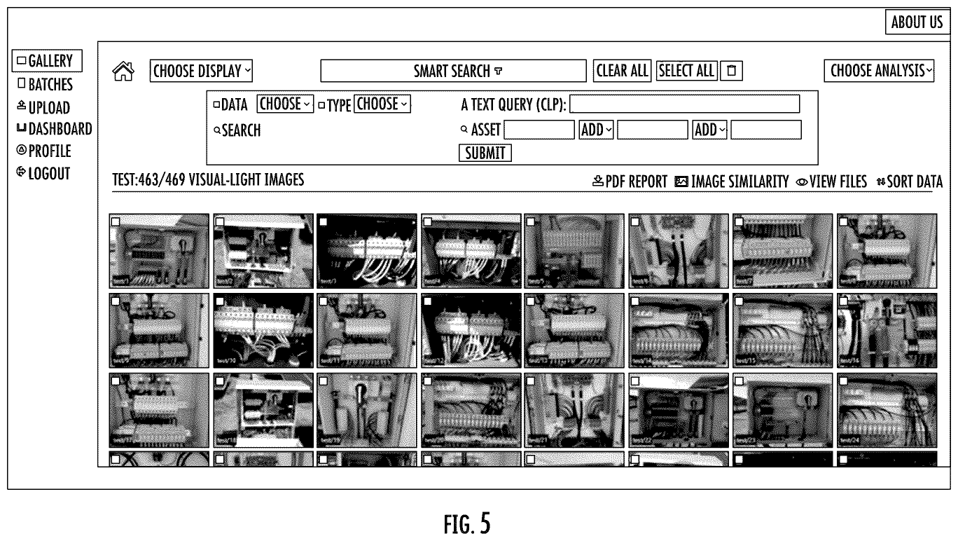

FIG. 5 provides an example user interface that enables a user to explore and select a particular set of data records according to example implementations of the present disclosure. This interface, designed for managing and analyzing image data, features a navigation bar for easy access to different functionalities such as gallery, upload, and profile management. It includes a display selection panel with dropdown menus and search fields that allow users to filter and display image data according to specific criteria. The central part of the interface displays thumbnails of images, which users can select for further analysis or reporting. This setup is particularly beneficial for environments requiring quick and efficient access to specific images, such as in quality control or maintenance inspections.

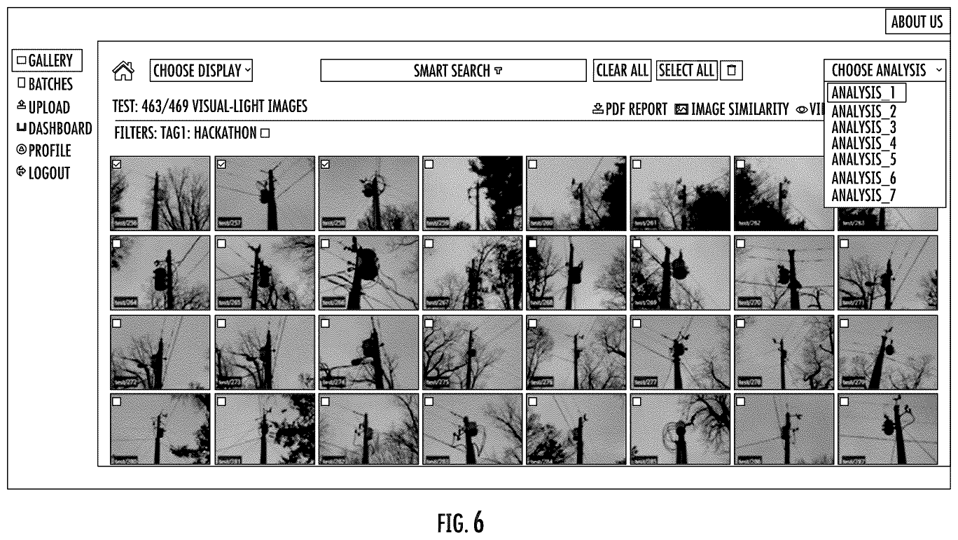

FIG. 6 provides another example user interface that enables a user to explore, select, and/or analyze a particular set of data records according to example implementations of the present disclosure. As an example, this interface facilitates the management of visual-light images with a navigation bar and a smart search feature that supports advanced searches using complex queries. The image display area shows thumbnails of the visual-light images, allowing users to select specific images for detailed analysis. For example, the pulldown at the top right selects different analysis options for the records shown and/or selected within the interface. This interface streamlines the process of image data management, enhancing the accuracy and effectiveness of data handling processes across various applications.

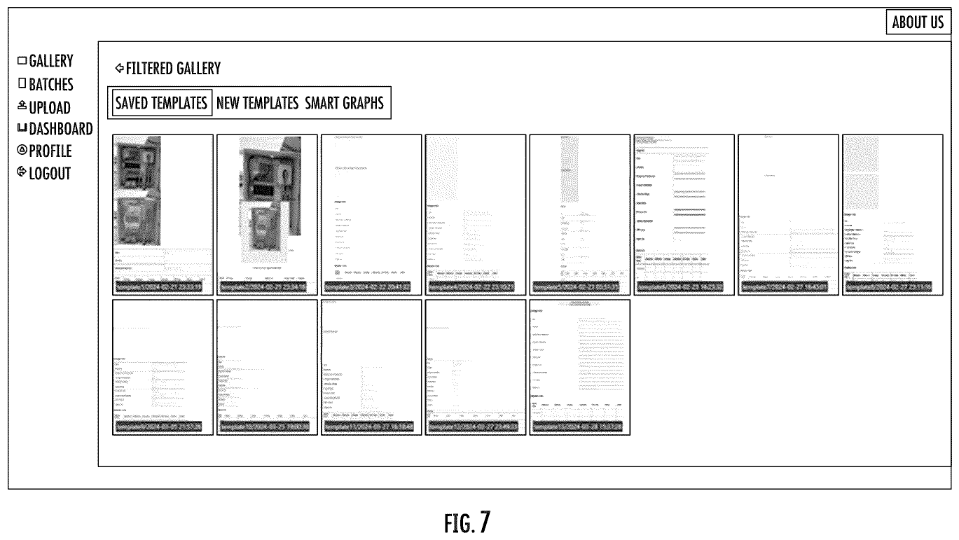

FIG. 7 provides an example user interface that enables a user to explore and select a report template from a set of saved templates according to example implementations of the present disclosure. The interface displays thumbnails of various report templates, which users can view or select for customization and use in report generation. A tab selection bar allows users to switch between viewing saved templates, creating new templates, or accessing advanced graphical tools, enhancing the flexibility and usability of the system. This interface is particularly useful in environments where efficient access to various report templates is useful.

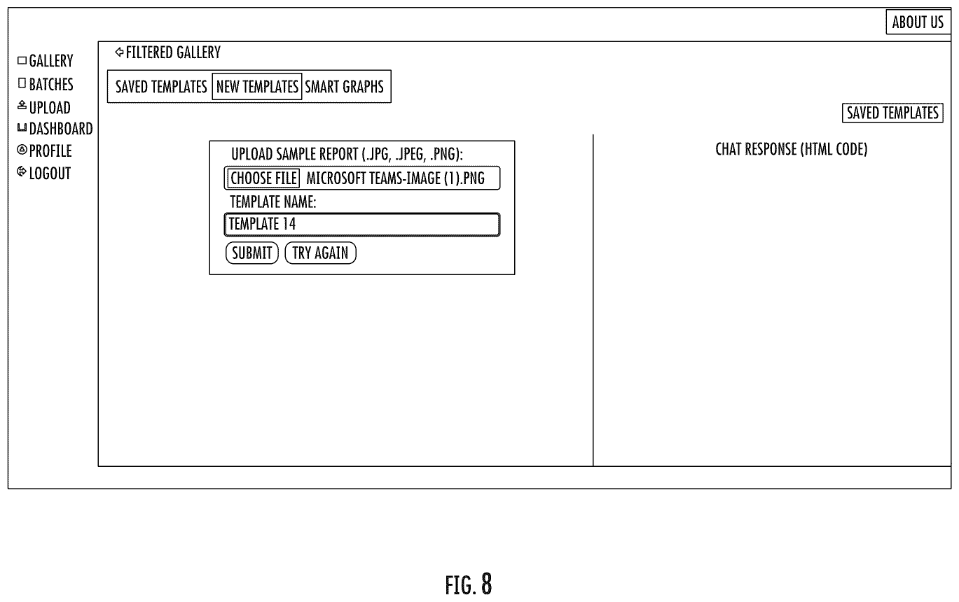

FIG. 8 provides an example user interface that ingests a prior report to create a new template according to example implementations of the present disclosure. Users can upload a sample report data file and assign a unique name to the new template being created. The system displays the processed HTML code generated from the uploaded report image, allowing users to review and verify the HTML structure extracted from the report image. This interface supports the ingestion of prior reports and the creation of customizable templates, enhancing the adaptability and effectiveness of report generation processes across various applications.

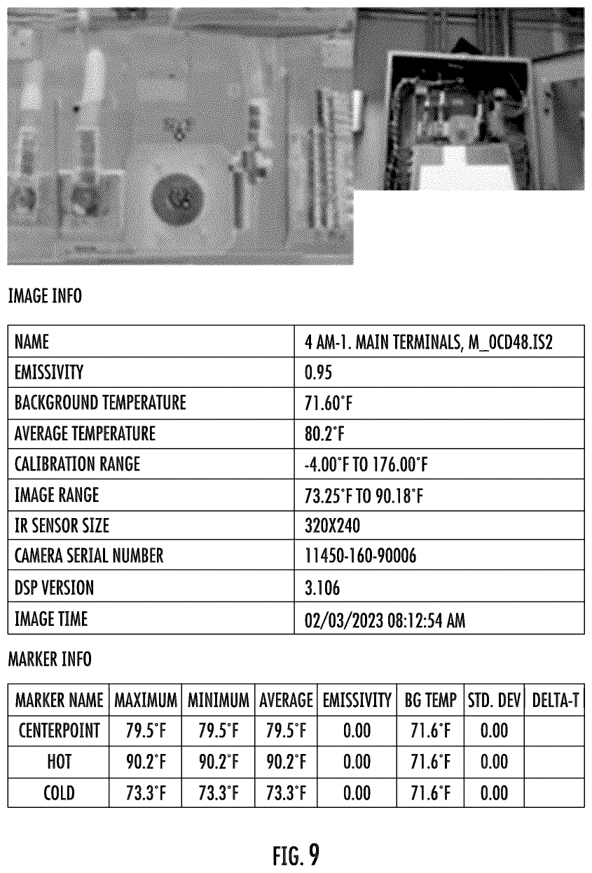

FIG. 9 illustrates an example report according to example implementations of the present disclosure. This report includes thermal images captured from a thermal imaging camera, displaying temperature variations across different components. Detailed sections provide metadata associated with the thermal images and statistical data related to specific markers within the images, crucial for comprehensive analysis and reporting. This example demonstrates how advanced data processing techniques, combined with intuitive report generation systems, can significantly enhance the analysis and presentation of complex reports.

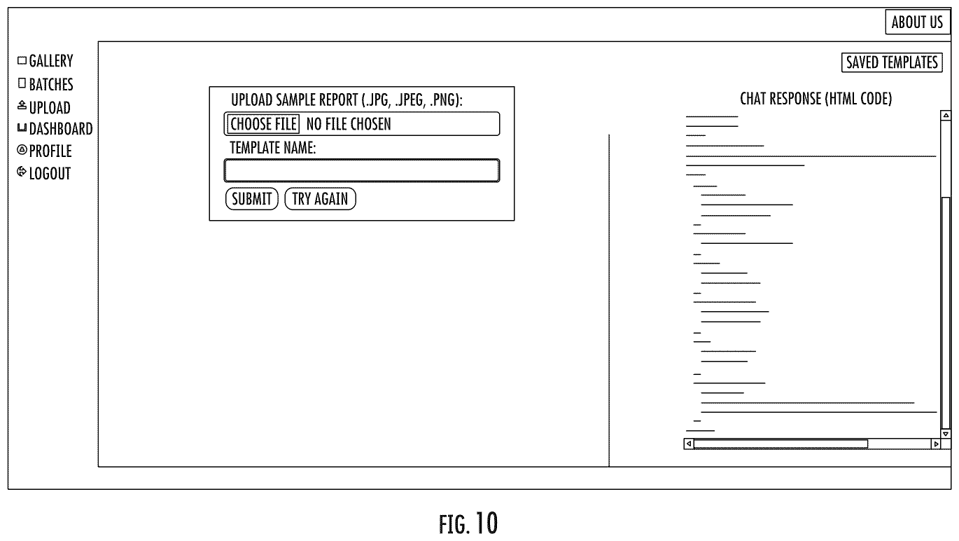

FIG. 10 provides an example user interface that displays the generated template report structure data to users in a panel on the right side according to example implementations of the present disclosure. This interface allows users to upload a sample report, view the generated HTML code for the template report structure, and save the newly created template into the system's template library. The display of processed HTML code serves as immediate feedback, enabling users to make real-time adjustments or corrections to the generated template structure.

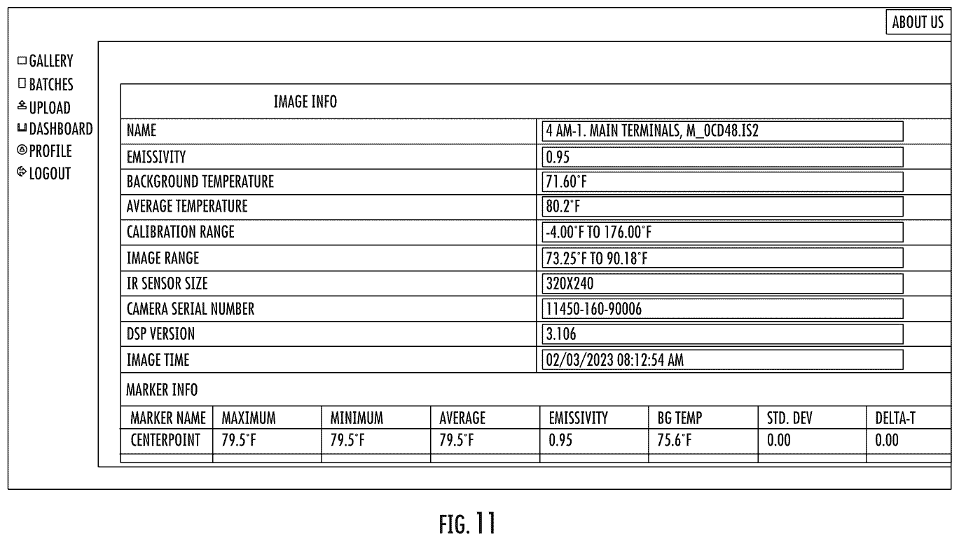

FIG. 11 provides an example user interface that displays a rendering of template report structure data to users according to example implementations of the present disclosure. This interface shows the structure of the ingested report file, including metadata such as name, emissivity, and temperature details. Users can interact with the interface to adjust the report structure such as label name, label location, etc.

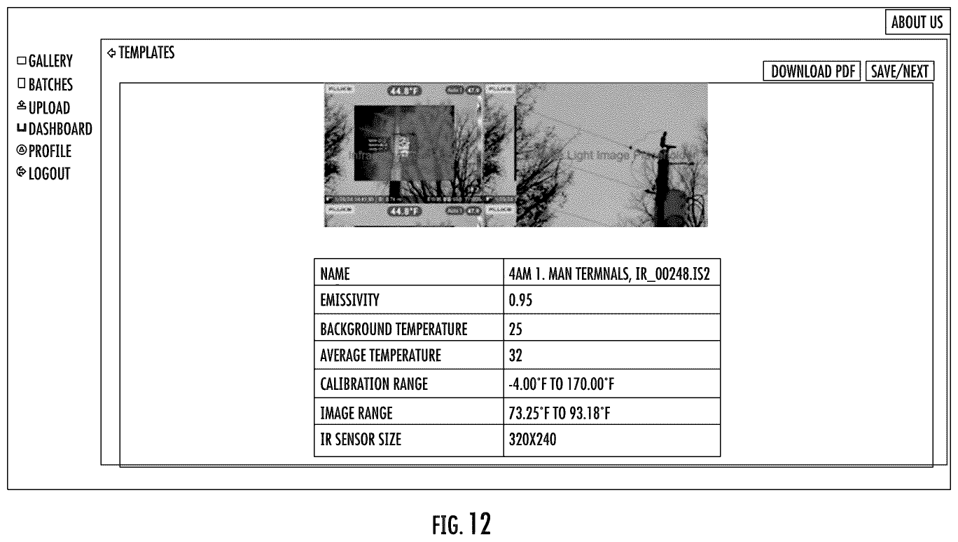

FIG. 12 provides an example user interface that displays a rendered report of populated report data to users according to example implementations of the present disclosure. This interface features a dual-panel layout displaying thermal and visible light images of the same scene, along with a detailed form containing metadata extracted from the images. This setup facilitates easy data verification and editing by users, enhancing the accuracy and reliability of the generated reports.

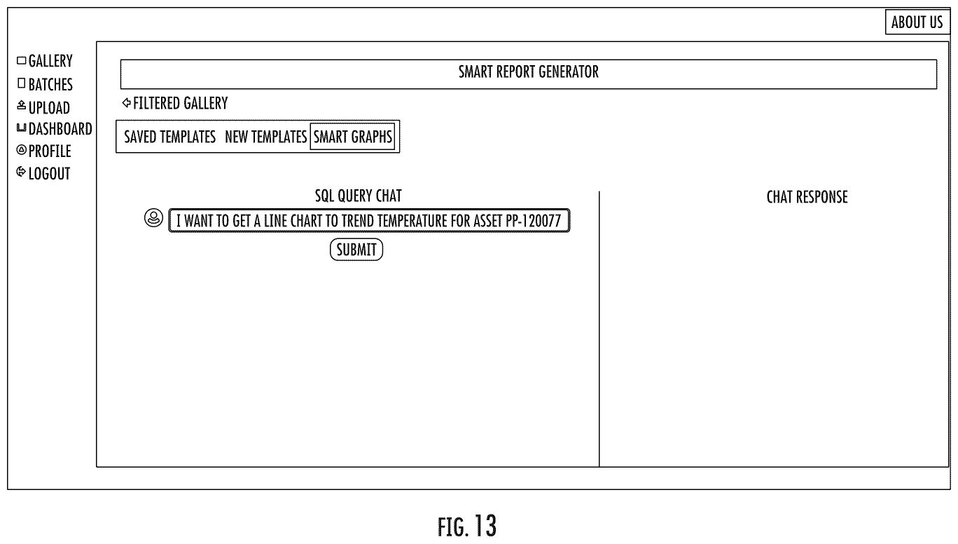

FIG. 13 provides an example user interface that enables a user to enter a natural language description of a report to be generated according to example implementations of the present disclosure. This interface includes an SQL Query Chat where users can type natural language queries to request specific types of data visualization or report outputs. The system processes these inputs and provides the requested output in the Chat Response area, demonstrating the system's ability to handle and process user inputs in a conversational format.

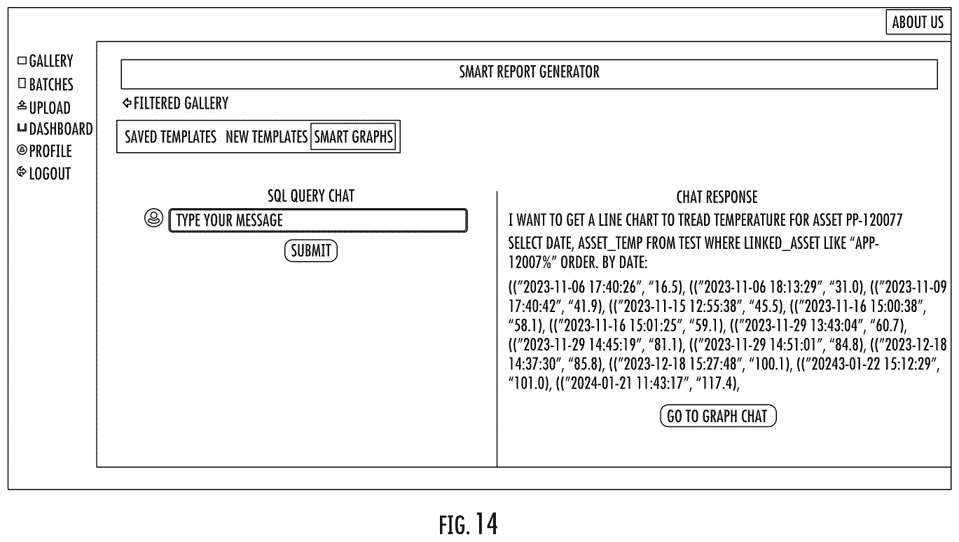

FIG. 14 provides an example user interface that displays the user input, the generated template report structure data, and the retrieved data records in the panel shown on the right side according to example implementations of the present disclosure. This interface allows for interactive communication between the user and the system through an SQL interface, enhancing the system's ability to process complex data queries and respond with accurate data outputs.

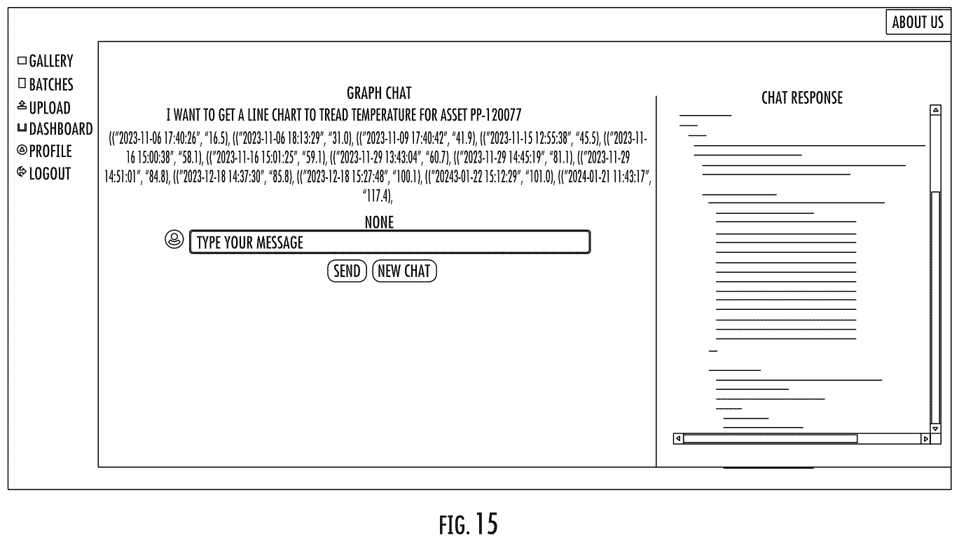

FIG. 15 provides an example user interface that displays the user input, the generated template report structure data for a graphical element such as a chart or graph, and the retrieved data records in the left side panel and displays the populated report data (e.g., in the form of HTML or XML) in the right side panel according to example implementations of the present disclosure. This interface supports dynamic interaction with the system, allowing users to provide edits or modifications to the report structure or content through user edits, enhancing the customization and relevance of the final report.

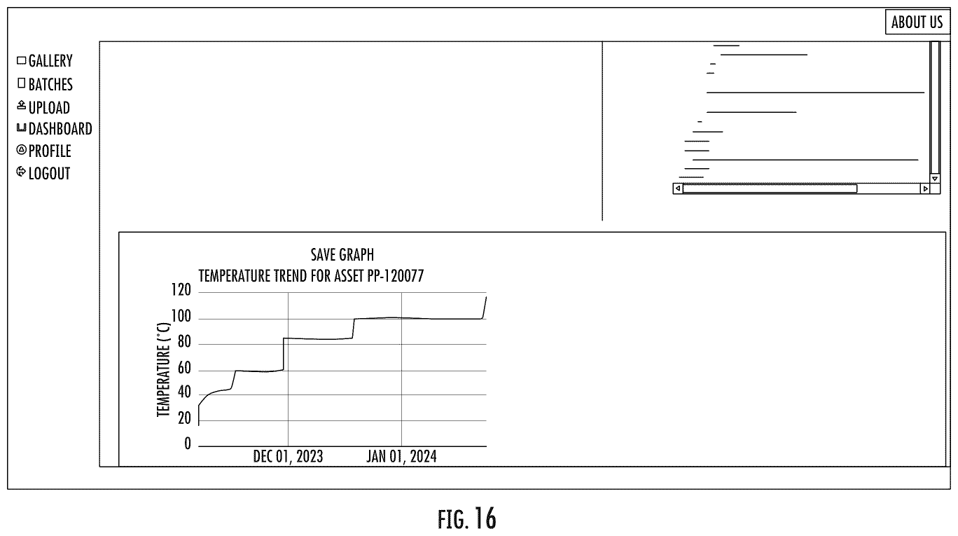

FIG. 16 provides an example user interface that displays a rendered report that includes a graphical depiction of data according to example implementations of the present disclosure. For example, FIG. 16 may correspond to a lower part of the interface from FIG. 15. Thus, in some cases, the user interface shown in FIG. 16 may be accessed by scrolling down from the user interface shown in FIG. 15. The interface shown in FIG. 16 shows a line chart illustrating data trends, with the underlying code used to generate the graphical data depiction displayed in a script display section. This setup not only facilitates easy data verification and editing by users but also enhances the visual communication of data insights within the generated reports.

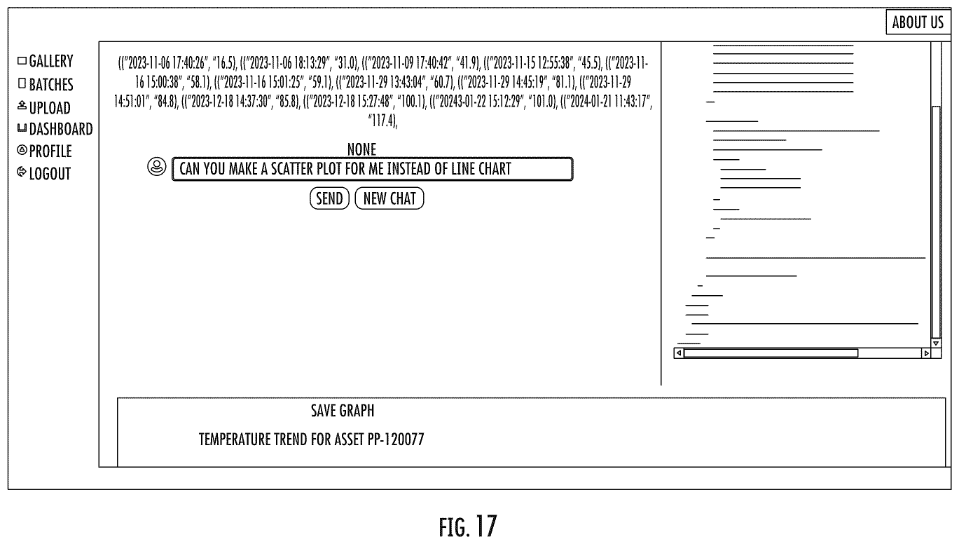

FIG. 17 provides an example user interface that enables a user to provide a user edit to a generated report according to example implementations of the present disclosure. This interface includes a chat interface where users can request modifications to the data visualizations within the report, such as changing a scatter plot to a line chart. The system processes these inputs and executes the necessary changes, demonstrating the system's responsiveness and adaptability to user inputs.

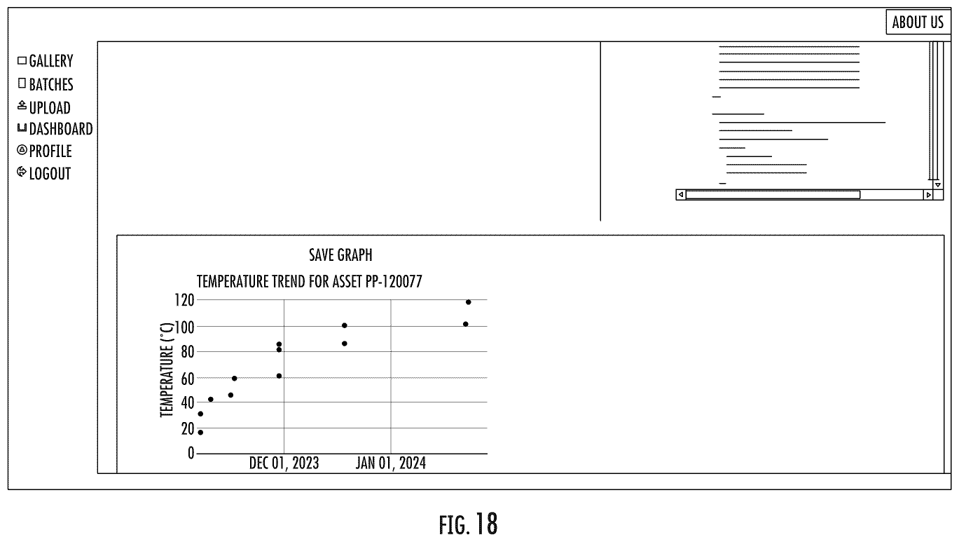

FIG. 18 provides an example user interface that displays a re-generated report that has been modified based on user feedback according to example implementations of the present disclosure. For example, FIG. 18 may correspond to a lower part of the interface from FIG. 17. Thus, in some cases, the user interface shown in FIG. 18 may be accessed by scrolling down from the user interface shown in FIG. 17. The interface shown in FIG. 18 shows a scatter plot with temperature data points, illustrating the system's capability to dynamically adapt to user feedback and integrate it into the visual representation of the report. This functionality enhances the system's utility in providing customized and accurate data presentations based on user preferences and inputs.

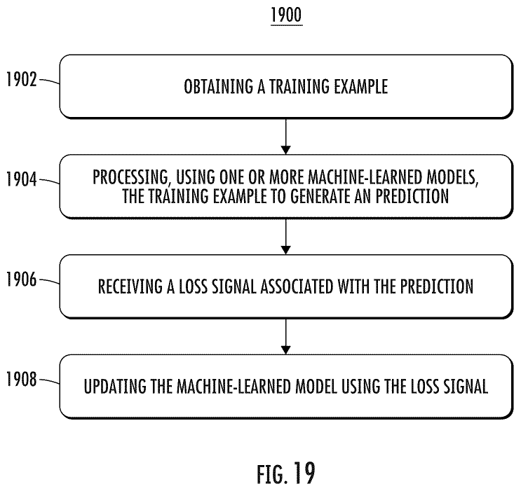

Referring now to FIG. 19, depicted is a flowchart diagram of an example method 1900 for training one or more machine-learned models. The method 1900 can facilitate the iterative process of refining a machine-learned model to improve its performance in generating predictions based on input data. The method 1900 can be implemented by a computing system that includes one or more computing devices, which can execute the steps of the method 1900 using one or more machine-learned models stored in memory.

At 1902, the method 1900 can include obtaining a training example. This training example can be a piece of data or a set of data used to train the machine-learned model. Training examples can be sourced from various datasets, and can be labeled or unlabeled, depending on the learning paradigm employed (e.g., supervised, unsupervised, semi-supervised, or reinforcement learning).

At 1904, the method 1900 can include processing the training example to generate a prediction. This step can involve using one or more machine-learned models to analyze the training example and produce an output. The output can be a direct prediction from the machine-learned model or can result from a sequence of processing operations that include the model's output. The processing can leverage various machine learning techniques, such as neural networks, decision trees, or support vector machines, to interpret the training example and derive a prediction.

At 1906, the method 1900 can include receiving a loss signal associated with the prediction. The loss signal can be computed using a loss function that measures the discrepancy between the predicted output and the ground truth or expected output. Different types of loss functions can be utilized, such as mean squared error for regression tasks or cross-entropy loss for classification tasks. The loss signal provides feedback on the accuracy of the prediction, which can be used to adjust the parameters of the machine-learned model.

At 1908, the method 1900 can include updating the machine-learned model using the loss signal. This step can involve adjusting the values of the model's parameters to minimize the loss signal, thereby improving the model's predictive capability. Techniques such as gradient descent or backpropagation can be employed to iteratively update the parameters based on the gradient of the loss signal with respect to the parameter values. This updating process can be performed over multiple training iterations, with the objective of converging to a set of parameter values that yield the best performance of the model on the training data.

The method 1900 can be part of a larger training procedure that includes pre-training, fine-tuning, and potentially refining the model with user feedback. Pre-training can involve training the model on a large-scale dataset to establish a broad performance base, while fine-tuning can focus on smaller-scale training on higher-quality data. User feedback can further refine the model's performance by incorporating real-world usage data and human evaluations.

In some implementations, the method 1900 can be adapted to various stages of model training, allowing for flexibility in the training process. For instance, certain portions of the machine-learned model can be “frozen” during fine-tuning to retain information learned from broader domains, or the method 1900 can be implemented for specific tasks such as online training or reinforcement learning based on runtime inferences.

Overall, the method 1900 provides a structured approach to training machine-learned models, enabling the iterative improvement of model performance through the acquisition of training examples, processing to generate predictions, receiving loss signals, and updating the model parameters. This structured training process can enhance the ability of machine-learned models to accurately predict outcomes and generalize to new, unseen data.

Example techniques for building, training, and/or finetuning sequence processing models (e.g., LLMs and LMMs) are described in the following references, and represent the general knowledge of one of skill in the art: Hoffmann, Jordan, et al. “Training compute-optimal large language models.” arXiv preprint arXiv: 2203.15556 (2022). Hoffmann, Jordan, et al. “An empirical analysis of compute-optimal large language model training.” Advances in Neural Information Processing Systems 35 (2022): 30016-30030. Wu, Shijie, et al. “Bloomberggpt: A large language model for finance.” arXiv preprint arXiv: 2303.17564 (2023).

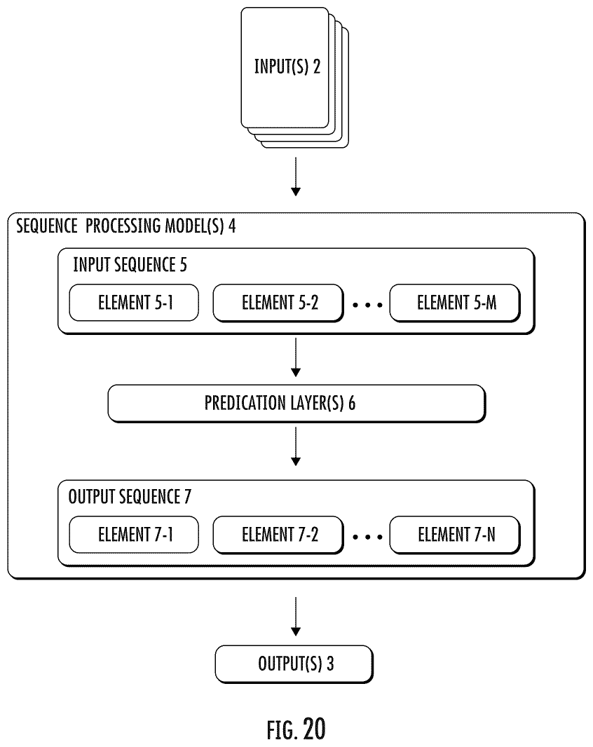

Referring now to FIG. 20, a block diagram illustrates an example implementation of a sequence processing model(s) 4 configured to process sequences of information. The sequence processing model(s) 4 can receive input(s) 2, which may include a variety of data types such as text, images, audio, or other forms of data. These input(s) 2 are then processed to obtain an input sequence 5, which is a representation of the data in a format understood by the sequence processing model(s) 4.

Sequence processing model(s) 4 can include one or multiple machine-learned model components configured to ingest, generate, or otherwise reason over sequences of information. For example, some example sequence processing models in the text domain are referred to as “Large Language Models,” or LLMs. Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, biochemical domains, by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

The input sequence 5 comprises a series of input elements, denoted as element 5-1, element 5-2, . . . , through element 5-M, where M represents the total number of elements in the input sequence 5. Each element within input sequence 5 can represent discrete or continuously distributed data points within an embedding space, capturing the essential information conveyed by input(s) 2.

The sequence processing model(s) 4 further include prediction layer(s) 6, which can process the input sequence 5 to generate an output sequence 7. The prediction layer(s) 6 are composed of one or more machine-learned model architectures that manipulate and transform the input elements to extract higher-order meaning and relationships between them. This transformation allows for the prediction of new output elements based on the context provided by the input sequence 5.

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Output sequence 7 is generated from prediction layer(s) 6 and includes a series of output elements, labeled as element 7-1, element 7-2, . . . , through element 7-N, where N represents the total number of elements in the output sequence 7. These output elements can be the result of autoregressive generation, where each likely next output element is sampled and added to the context window for subsequent predictions. Alternatively, output sequence 7 can be generated non-autoregressively, predicting multiple output elements together without sequential conditioning.

The system can then generate output(s) 3 based on the output sequence 7. These output(s) 3 can be utilized in various applications, such as content generation, classification, or instruction implementation, depending on the nature of the input(s) 2 and the configuration of the sequence processing model(s) 4.

In some implementations, sequence processing model(s) 4 can be adapted for specific tasks or data domains. For instance, sequence processing model(s) 4 can be configured to process textual input for natural language understanding tasks or image-based input for visual recognition tasks. The flexibility of sequence processing model(s) 4 allows them to handle multimodal input sequences, facilitating information extraction and reasoning across diverse data modalities.

Alternative implementations may include sequence processing model(s) 4 with different configurations of prediction layer(s) 6, such as transformer-based architectures, recurrent neural networks (RNNs), long short-term memory (LSTM) models, or convolutional neural networks (CNNs). These various architectures can enable sequence processing model(s) 4 to understand or generate sequences of information that are tailored to the specific requirements of the application at hand.

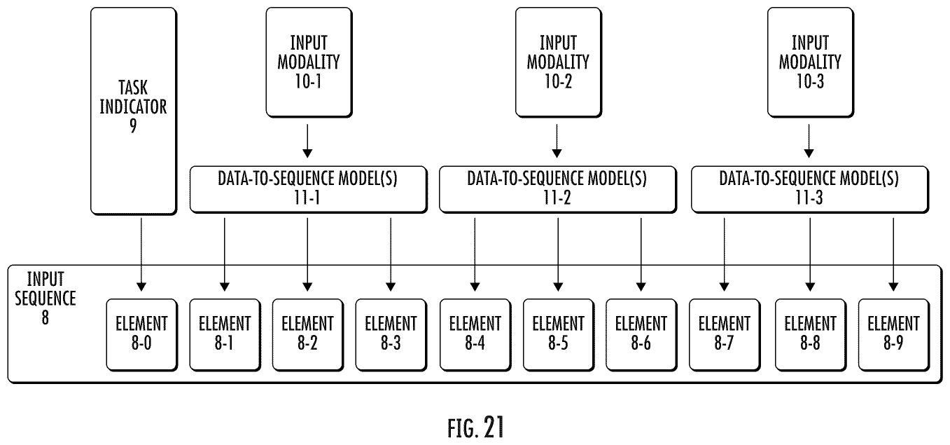

Referring now to FIG. 21, a block diagram illustrates an example implementation of a multi-modal sequence processing model that can populate an input sequence 8. Central to this implementation is the task indicator 9, which can provide a signal to the model(s) processing the input sequence 8, indicating the specific task being performed. This task indicator 9 can include a model or component configured to identify a particular task and inject a corresponding input value into the input sequence 8, represented by element 8-0. The input value can be a learned representation within a continuous embedding space, signaling to the model(s) the nature of the task at hand.

The system further includes various input modalities, such as input modality 10-1, input modality 10-2, and input modality 10-3, each associated with different data types. For instance, input modality 10-1 might represent textual data, input modality 10-2 might represent image data, and input modality 10-3 might represent audio data. Each input modality can provide a unique set of data that contributes to the multimodal nature of the input sequence 8.

Data-to-sequence models, specifically data-to-sequence model(s) 11-1, data-to-sequence model(s) 11-2, and data-to-sequence model(s) 11-3, are adapted to project data from their respective input modalities into a format compatible with the input sequence 8. These models can transform the data to obtain elements 8-1, 8-2, 8-3, etc., for input modality 10-1; elements 8-4, 8-5, 8-6, etc., for input modality 10-2; and elements 8-7, 8-8, 8-9, etc., for input modality 10-3. The elements within input sequence 8 can indicate specific locations within a multidimensional embedding space, mapping to discrete or continuously distributed locations depending on the nature of the data.

In some implementations, the data-to-sequence models 11-1, 11-2, and 11-3 can be trained jointly or independently from the machine-learned sequence processing model(s) 4 to facilitate end-to-end training. These models can form part of the machine-learned sequence processing model(s) 4 illustrated in FIG. 20, enhancing the system's ability to extract and reason over information from diverse data modalities.

The input sequence 8, as depicted in FIG. 21, represents a multimodal input sequence that contains elements from different data modalities using a common dimensional representation. This enables the system to process and reason over a variety of data types, facilitating complex tasks such as information extraction, content generation, or decision-making processes. The elements within input sequence 8, such as elements 8-0 through 8-9, can be processed by subsequent components of the system. For example, with reference to FIG. 20, the input sequence 8 from FIG. 21 can be processed with the prediction layer(s) 6, to generate an output sequence that can drive the generation of outputs 3 based on the processed multimodal data.

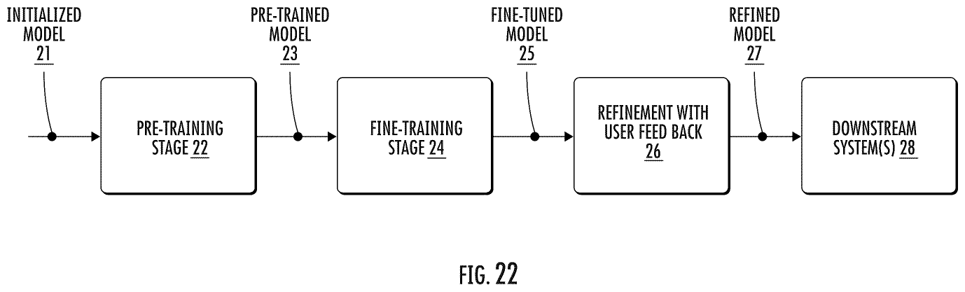

Referring now to FIG. 22, an example training flow for training a machine-learned model is depicted. The training flow illustrates the progression of a model through various stages, beginning with an initialized model 21 and culminating in a refined model 27 that can be output to downstream system(s) 28 for deployment or further development.

The initialized model 21 represents the starting point of the training process. This model can be in an initial state, with weight values that are either randomly assigned or based on an initialization schema. In some cases, the initial weight values can be derived from prior pre-training for the same or different models, providing a foundation upon which further training can be built.

The pre-training stage 22 signifies the initial phase of training, where the initialized model 21 undergoes large-scale training over potentially noisy data to achieve a broad base of performance levels across various tasks or data types. Pre-training stage 22 can be implemented using one or more pre-training pipelines that operate over data from dataset(s). This stage can be omitted if the initialized model 21 is already pre-trained, such as when the model contains, is, or is based on a pre-trained foundational model or an expert model.

Upon completion of the pre-training stage 22, the model transitions to a pre-trained model 23. This model can then undergo fine-tuning in the fine-tuning stage 24, where smaller-scale training is conducted on higher-quality data, such as labeled or curated datasets. Fine-tuning stage 24 can be facilitated by one or more fine-tuning pipelines, which refine the performance of pre-trained model 23 to meet specific performance criteria or to adapt to a narrower domain present in the fine-tuning dataset(s).

The fine-tuned model 25 represents the outcome of fine-tuning stage 24, which can then be subjected to refinement with user feedback 26. This stage involves incorporating feedback from human users to further enhance the model's performance. Refinement with user feedback 26 can include reinforcement learning techniques and can be based on human feedback on the model's performance during use.

The refined model 27 emerges from the refinement with user feedback 26 as an updated version of development model 16, which can then be output to downstream system(s) 28. Downstream system(s) 28 can be any system or platform where the refined model 27 is deployed for practical application or further development.

Overall, FIG. 22 provides a structured representation of the training flow for a machine-learned model, outlining the systematic approach to evolving the model from an initial state to a fully refined state ready for practical application or further development.

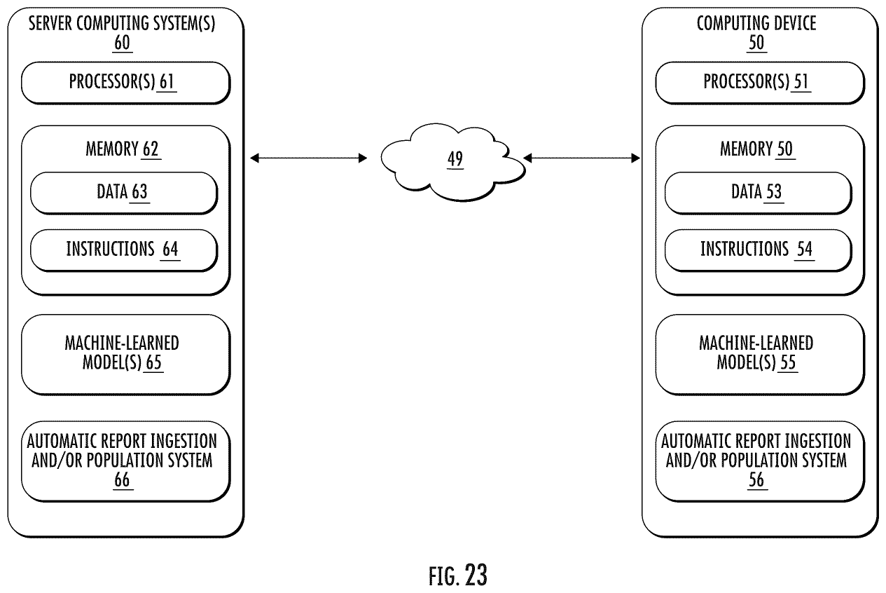

Referring now to FIG. 23, a block diagram is presented that illustrates an example networked computing system capable of performing various aspects of the disclosed machine learning-based report completion techniques. The system includes a plurality of computing devices and systems that are interconnected via a network, facilitating cooperative interactions to execute the disclosed methods.

The example computing device 50 can represent a diverse range of computing devices, such as personal computing devices, mobile devices, or server computing devices. Computing device 50 includes one or more processors 51, which can be any suitable processing device such as a microprocessor or a controller. These processors 51 can execute data 53 and instructions 54 stored in memory 52 to perform operations that implement features of the present disclosure. Memory 52 can be a non-transitory computer-readable storage medium, such as RAM or flash memory devices.

Computing device 50 can also include machine-learned models 55, which can be loaded into memory 52 and utilized by processors 51 for various tasks, such as drafting patent applications or training on patent-related data. These machine-learned models 55 can be developed locally on computing device 50 or received from other systems like server computing system(s) 60.

Server computing system(s) 60 can mirror the structure of computing device 50, comprising processors 61 and memory 62 that store data 63 and instructions 64. Server computing system(s) 60 can also include machine-learned models 65, which can be the same as or different from machine-learned models 55 on computing device 50. These models 65 can be used to host or serve model inferences for client devices, potentially implementing machine-learned models in a client-server relationship.

Network 49 serves as the communication medium that enables data exchange between computing device 50 and server computing system(s) 60. Network 49 can be any type of communications network, such as the internet, and can support various communication protocols and encodings to facilitate secure and efficient data transmission.

In some implementations, computing device 50 and server computing system(s) 60 can operate in a distributed computing environment, where server computing system(s) 60 manage the implementation of machine-learned models 65, and computing device 50 acts as a client device accessing the services provided by server computing system(s) 60. This configuration can allow for remote performance of inference and training operations, with outputs returned to computing device 50 for further use or analysis.

The server computing system(s) 60 and/or the computing device 50 can include and collaboratively operate to implement an automatic report ingestion and/or population system as described herein. For example, some or all of the automatic report ingestion and/or population system can be implemented by the server computing system(s) 60 (e.g., shown at system 66). For example, the server computing system(s) 60 can implement the automatic report ingestion and/or population system 66 as a web application or software as a service. Additionally or alternatively, some or all of the automatic report ingestion and/or population system can be implemented by the computing device 50 (e.g., shown at system 56). For example, the computing device 50 can implement the automatic report ingestion and/or population system 56 using locally stored and executed computer code (e.g., software). Thus, server computing system(s) 60 and/or the computing device 50 can include and execute computer instructions stored on computer-readable media to implement the systems and methods described herein.

The disclosed networked computing system exemplifies a versatile and scalable platform for implementing the advanced machine learning techniques described herein. By leveraging the interconnected nature of the computing devices and systems, the disclosed methods can be executed in a manner that optimizes resource utilization and maximizes the capabilities of the machine-learned models.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method for automatic generation of reports. The computer-implemented method includes obtaining, by a computing system may include one or more computing devices, a data file associated with a prior instance of a report or report type. The method also includes processing, by the computing system, the data file with one or more machine-learned sequence processing models to generate template report structure data as an output of the one or more machine-learned sequence processing models, where the template report structure data defines a template structure of the report or report type. The method also includes retrieving, by the computing system, one or more data records from a datastore based on a user input. The method also includes processing, by the computing system, the template report structure data and the retrieved one or more data records with the one or more machine-learned sequence processing models to generate populated report data as an output of the one or more machine-learned sequence processing models, where the populated report data may include a new instance of the report or report type that is structured according to the template report structure data and populated according to the one or more data records.

Other embodiments of this aspect include corresponding computer systems, apparatus, and computer programs recorded on one or more computer storage devices, each configured to perform the actions of the methods.

Example implementations may include any combination of one or more of the following features. The computer-implemented method where processing, by the computing system, the data file with the one or more machine-learned sequence processing models to generate the template report structure data may include: processing, by the computing system, the data file with a first instantiation of the one or more machine-learned sequence processing models to generate an initial set of template report structure data as an output of the first instantiation of the one or more machine-learned sequence processing models; and processing, by the computing system, the data file, the initial set of template report structure data, and a reinforcement prompt with a second instantiation of the one or more machine-learned sequence processing models to generate the template report structure data as an output of the second instantiation of the one or more machine-learned sequence processing models; where the reinforcement prompt instructs the second instantiation of the one or more machine-learned sequence processing models to refine the initial set of template report structure data based on a set of guidelines. One or both of the first instantiation or the second instantiation have been finetuned on a supervised training dataset, where the supervised training dataset may include training pairs, each training pair may include a training image of a training report and a set of ground truth template report structure data for the training report along with a system configuration prompt that provides instructions for content moderation or data retrieval. Processing, by the computing system, the data file with the one or more machine-learned sequence processing models to generate the template report structure data may include: processing, by the computing system, the data file and a label identification prompt with the one or more machine-learned sequence processing models to generate a dictionary of data labels as an output of the one or more machine-learned sequence processing models; where the label identification prompt instructs the one or more machine-learned sequence processing models to identify a set of labels contained in the prior rendering of the report or report type; and where the template report structure data includes or is based on the dictionary of data labels. The dictionary of data labels may identify a set of key-value pairs associated with a datastore. The method further may include, prior to processing the template report structure data and the retrieved one or more data records with the one or more machine-learned sequence processing models: providing, by the computing system, the template report structure data for display to a user within a user interface; receiving and entering, by the computing system, one or more edits to the template report structure data based on user inputs received at the user interface; and storing, by the computing system, the edited template report structure data in a data store. The computer-implemented method may include: finetuning, by the computing system, at least one of the one or more machine-learned sequence processing models, based on the one or more edits to the template report structure data. The user inputs received at the user interface may include one or more natural language statements, and where entering, by the computing system, the one or more edits to the template report structure data may include processing the one or more natural language statements and the template report structure data with the one or more sequence processing models to edit the template report structure data. Processing, by the computing system, the template report structure data and the retrieved one or more data records with the one or more machine-learned sequence processing models to generate the populated report data may include processing, by the computing system, the template report structure data, the retrieved one or more data records, and a datastore description prompt with the one or more machine-learned sequence processing models to generate the populated report data, where the datastore description prompt may include a description of a structure or schema of the datastore from which the one or more data records were retrieved. The datastore description prompt describes fields contained in the datastore, and where the data records may include diagnostic data for inclusion in the report or report type. The report or report type may include a graphical data depiction, and where the populated report data may include graphical data for rendering the graphical data depiction. Processing, by the computing system, the template report structure data and the retrieved one or more data records with the one or more machine-learned sequence processing models to generate the populated report data may include processing, by the computing system, the template report structure data, the retrieved one or more data records, and a graphics library description prompt with the one or more machine-learned sequence processing models to generate the populated report data, where the graphics library description prompt may include a description of a graphics library for building graphical data depictions. The computer-implemented method may include receiving one or more natural language statements input by the user, and processing the one or more natural language statements and the template report structure data with the one or more sequence processing models to edit portions of the template report structure data that correspond to the graphical data depiction. Retrieving, by the computing system, the one or more data records from the datastore based on the user input may include: receiving, by the computing system via a graphical user interface, the user input that specifies one or more data elements; and retrieving, by the computing system, the data records from the datastore that are associated with the one or more data elements. Retrieving, by the computing system, the one or more data records from the datastore based on the user input may include: receiving, by the computing system, the user input that may include a query expression; and querying, by the computing system, the datastore with the query expression to retrieve the one or more data records. Retrieving, by the computing system, the one or more data records from the datastore based on the user input may include: receiving, by the computing system, the user input that may include a natural language expression; processing, by the computing system, the natural language expression with the one or more machine-learned sequence processing models to generate a model-generated query expression as an output of the one or more machine-learned sequence processing models; and querying, by the computing system, the datastore with the model-generated query expression to retrieve the one or more data records. The data file may include an image file, a rich text format file, or a portable document format file. The template report structure data may include first hypertext markup language data, and where the populated report data may include second hypertext markup language data. The method further may include: rendering, by the computing system, the populated report data with a rendering engine to generate a newly rendered report; and providing, by the computing system, the newly rendered report for display to a user within a user interface. Implementations of the described techniques may include hardware, a method or process, or computer software on a computer-accessible medium.

One general aspect includes a computing system for automatic generation of reports. The computing system includes a report ingestion system configured to: obtain a data file associated with a prior instance of a report; process the data file with one or more machine-learned sequence processing models to generate template report structure data as an output of the one or more machine-learned sequence processing models, where the template report structure data defines a template structure of the report or report type. The system also includes a data retrieval system configured to retrieve one or more data records from a datastore based on a user input. The system also includes a report completion system configured to process the template report structure data and the retrieved one or more data records with the one or more machine-learned sequence processing models to generate populated report data as an output of the one or more machine-learned sequence processing models, where the populated report data may include a new instance of the report or report type that is structured according to the template report structure data and populated according to the one or more data records.

Other embodiments of this aspect include corresponding computer systems, apparatus, and computer programs recorded on one or more computer storage devices, each configured to perform the actions of the methods.

Example implementations may include any combination of one or more of the following features. The computing system where to process the data file with the one or more machine-learned sequence processing models to generate the template report structure data the report ingestion system is configured to: process the data file with a first instantiation of the one or more machine-learned sequence processing models to generate an initial set of template report structure data as an output of the first instantiation of the one or more machine-learned sequence processing models; and process the data file, the initial set of template report structure data, and a reinforcement prompt with a second instantiation of the one or more machine-learned sequence processing models to generate the template report structure data as an output of the second instantiation of the one or more machine-learned sequence processing models; where the reinforcement prompt instructs the second instantiation of the one or more machine-learned sequence processing models to refine the initial set of template report structure data based on a set of guidelines. To process the data file with the one or more machine-learned sequence processing models to generate the template report structure data the report ingestion system may be configured to: process the data file and a label identification prompt with the one or more machine-learned sequence processing models to generate a dictionary of data labels as an output of the one or more machine-learned sequence processing models; where the label identification prompt instructs the one or more machine-learned sequence processing models to identify a set of labels contained in the prior rendering of the report or report type; and where the template report structure data includes or is based on the dictionary of data labels. The data retrieval system is configured to use the one or more sequence processing models and a datastore description prompt to map the dictionary of data labels to corresponding fields in the datastore.

Implementations of the described techniques may include hardware, a method or process, or computer software on a computer-accessible medium.

What is claimed is:

1. A computer-implemented method for automatic generation of reports, the method comprising:
obtaining, by a computing system comprising one or more computing devices, a data file associated with a prior instance of a report or report type;
processing, by the computing system, the data file with one or more machine-learned sequence processing models to generate template report structure data as an output of the one or more machine-learned sequence processing models, wherein the template report structure data defines a template structure of the report or report type;
retrieving, by the computing system, one or more data records from a datastore based on a user input; and
processing, by the computing system, the template report structure data and the retrieved one or more data records with the one or more machine-learned sequence processing models to generate populated report data as an output of the one or more machine-learned sequence processing models, wherein the populated report data comprises a new instance of the report or report type that is structured according to the template report structure data and populated according to the one or more data records.

2. The computer-implemented method of claim 1, wherein processing, by the computing system, the data file with the one or more machine-learned sequence processing models to generate the template report structure data comprises:
processing, by the computing system, the data file with a first instantiation of the one or more machine-learned sequence processing models to generate an initial set of template report structure data as an output of the first instantiation of the one or more machine-learned sequence processing models; and
processing, by the computing system, the data file, the initial set of template report structure data, and a reinforcement prompt with a second instantiation of the one or more machine-learned sequence processing models to generate the template report structure data as an output of the second instantiation of the one or more machine-learned sequence processing models;
wherein the reinforcement prompt instructs the second instantiation of the one or more machine-learned sequence processing models to refine the initial set of template report structure data based on a set of guidelines.

3. The computer-implemented method of claim 2, wherein one or both of the first instantiation or the second instantiation have been finetuned on a supervised training dataset, wherein the supervised training dataset comprises training pairs, each training pair comprising a training image of a training report and a set of ground truth template report structure data for the training report along with a system configuration prompt that provides instructions for content moderation or data retrieval.

4. The computer-implemented method of claim 1, wherein processing, by the computing system, the data file with the one or more machine-learned sequence processing models to generate the template report structure data comprises:
processing, by the computing system, the data file and a label identification prompt with the one or more machine-learned sequence processing models to generate a dictionary of data labels as an output of the one or more machine-learned sequence processing models;
wherein the label identification prompt instructs the one or more machine-learned sequence processing models to identify a set of labels contained in the prior rendering of the report or report type; and
wherein the template report structure data includes or is based on the dictionary of data labels.

5. The computer-implemented method of claim 4, wherein the dictionary of data labels identifies a set of key-value pairs associated with a datastore.

6. The computer-implemented method of claim 1, wherein the method further comprises, prior to processing the template report structure data and the retrieved one or more data records with the one or more machine-learned sequence processing models:
providing, by the computing system, the template report structure data for display to a user within a user interface;
receiving and entering, by the computing system, one or more edits to the template report structure data based on user inputs received at the user interface; and
storing, by the computing system, the edited template report structure data in a data store.

7. The computer-implemented method of claim 6, further comprising:
finetuning, by the computing system, at least one of the one or more machine-learned sequence processing models, based on the one or more edits to the template report structure data.

8. The computer-implemented method of claim 6, wherein the user inputs received at the user interface comprise one or more natural language statements, and wherein entering, by the computing system, the one or more edits to the template report structure data comprises processing the one or more natural language statements and the template report structure data with the one or more sequence processing models to edit the template report structure data.

9. The computer-implemented method of claim 1, wherein processing, by the computing system, the template report structure data and the retrieved one or more data records with the one or more machine-learned sequence processing models to generate the populated report data comprises processing, by the computing system, the template report structure data, the retrieved one or more data records, and a datastore description prompt with the one or more machine-learned sequence processing models to generate the populated report data, wherein the datastore description prompt comprises a description of a structure or schema of the datastore from which the one or more data records were retrieved.

10. The computer-implemented method of claim 9, wherein the datastore description prompt describes fields contained in the datastore, and wherein the data records comprise diagnostic data for inclusion in the report or report type.

11. The computer-implemented method of claim 1, wherein the report or report type comprises a graphical data depiction, and wherein the populated report data comprises graphical data for rendering the graphical data depiction.

12. The computer-implemented method of claim 11, wherein processing, by the computing system, the template report structure data and the retrieved one or more data records with the one or more machine-learned sequence processing models to generate the populated report data comprises processing, by the computing system, the template report structure data, the retrieved one or more data records, and a graphics library description prompt with the one or more machine-learned sequence processing models to generate the populated report data, wherein the graphics library description prompt comprises a description of a graphics library for building graphical data depictions.

13. The computer-implemented method of claim 11, further comprising receiving one or more natural language statements input by the user, and processing the one or more natural language statements and the template report structure data with the one or more sequence processing models to edit portions of the template report structure data that correspond to the graphical data depiction.

14. The computer-implemented method of claim 1, wherein retrieving, by the computing system, the one or more data records from the datastore based on the user input comprises:
receiving, by the computing system via a graphical user interface, the user input that specifies one or more data elements; and
retrieving, by the computing system, the data records from the datastore that are associated with the one or more data elements.

15. The computer-implemented method of claim 1, wherein retrieving, by the computing system, the one or more data records from the datastore based on the user input comprises:
receiving, by the computing system, the user input that comprises a query expression; and
querying, by the computing system, the datastore with the query expression to retrieve the one or more data records.

16. The computer-implemented method of claim 1, wherein retrieving, by the computing system, the one or more data records from the datastore based on the user input comprises:
receiving, by the computing system, the user input that comprises a natural language expression;
processing, by the computing system, the natural language expression with the one or more machine-learned sequence processing models to generate a model-generated query expression as an output of the one or more machine-learned sequence processing models; and
querying, by the computing system, the datastore with the model-generated query expression to retrieve the one or more data records.

17. The computer-implemented method of claim 1, wherein the data file comprises an image file, a Rich Text Format file, or a Portable Document Format file.

18. The computer-implemented method of claim 1, wherein the template report structure data comprises first Hypertext Markup Language data, and wherein the populated report data comprises second Hypertext Markup Language data.

19. The computer-implemented method of claim 1, wherein the method further comprises:
rendering, by the computing system, the populated report data with a rendering engine to generate a newly rendered report; and
providing, by the computing system, the newly rendered report for display to a user within a user interface.

20. A computing system for automatic generation of reports, the computing system comprising:
a report ingestion system configured to:
obtain a data file associated with a prior instance of a report; and
process the data file with one or more machine-learned sequence processing models to generate template report structure data as an output of the one or more machine-learned sequence processing models, wherein the template report structure data defines a template structure of the report or report type;
a data retrieval system configured to retrieve one or more data records from a datastore based on a user input; and
a report completion system configured to process the template report structure data and the retrieved one or more data records with the one or more machine-learned sequence processing models to generate populated report data as an output of the one or more machine-learned sequence processing models, wherein the populated report data comprises a new instance of the report or report type that is structured according to the template report structure data and populated according to the one or more data records.

21. The computing system of claim 20, wherein to process the data file with the one or more machine-learned sequence processing models to generate the template report structure data the report ingestion system is configured to:
process the data file with a first instantiation of the one or more machine-learned sequence processing models to generate an initial set of template report structure data as an output of the first instantiation of the one or more machine-learned sequence processing models; and
process the data file, the initial set of template report structure data, and a reinforcement prompt with a second instantiation of the one or more machine-learned sequence processing models to generate the template report structure data as an output of the second instantiation of the one or more machine-learned sequence processing models;
wherein the reinforcement prompt instructs the second instantiation of the one or more machine-learned sequence processing models to refine the initial set of template report structure data based on a set of guidelines.

22. The computing system of claim 20, wherein to process the data file with the one or more machine-learned sequence processing models to generate the template report structure data the report ingestion system is configured to:
process the data file and a label identification prompt with the one or more machine-learned sequence processing models to generate a dictionary of data labels as an output of the one or more machine-learned sequence processing models;
wherein the label identification prompt instructs the one or more machine-learned sequence processing models to identify a set of labels contained in the prior rendering of the report or report type; and
wherein the template report structure data includes or is based on the dictionary of data labels.

23. The computing system of claim 22, wherein the data retrieval system is configured to use the one or more sequence processing models and a datastore description prompt to map the dictionary of data labels to corresponding fields in the datastore.
